(19) United States
(12) Patent Application Publication
(10) Pub. No.: US 2012/0096651 A1
(43) Pub. Date: Apr. 26, 2012

(54) WET DETERGENT WIPE

(75) Inventors: Wolfgang TENBUSCH, Bremen (DE); Michael PULINA, Krefeld (DE)

(73) Assignee: ALBAAD DEUTSCHLAND GMBH, Ochtrup (DE)

(21) Appl. No.: 13/111,302

(22) Filed: May 19, 2011

(30) Foreign Application Priority Data
Oct. 22, 2010 (DE) 10 2010 060 126.8

(51) Int. Cl. D06L 1/20; B05D 1/36; B05D 5/00; C11D 17/06

(52) U.S. Cl. 8/137; 510/298; 427/402

(57) ABSTRACT

A method of making a wet detergent wipe comprising the following steps; Adsorbing a tenside in the carrier material and impregnating with a detergent solution the carrier material so functionalized. The wet detergent wipe is used for cleaning textiles by introducting it directly into the drum of a washing-machine.

### FIELD OF THE INVENTION

The present invention relates to wet coths or wipes which are wetted with a detergent lotion. In particular, the invention especially relates to impregnated wipes or sheets for cleaning textiles and to cloths or sheets of this kind for the well-aimed conditioning and preparation of textile surfaces.

### BACKGROUND OF THE INVENTION AND STATE OF THE ART

Among the desires of humans is the cleaning and care of their clothes. Especially since the beginning of the 20th century, numerous products for cleaning textiles were developed and added to the classical soaps (“rinse off”). In addition to detergents in powder form, liquid detergents and detergent concentrates were provided to optimize the handling of dosages as well as sustainability.

In addition to quality concerns in textile cleaning, sustainability has become an increasingly significant issue, giving rise to a strong demand for novel detergents, which for this reason were able to develop into a new product area. In addition to form of use (solid powder, liquid detergents), the fields of application were diversified with regard to quality. In addition to those for white laundry (including brighteners, for example), detergents were offered specifically for coloured and black articles of laundry. The use of enzymes is an essential contribution to the optimized washing performance an additive provides, with amylase and protease, for example, of particular importance in the context. These enzymes are known to facilitate the removal of stubborn stains and deposits (e.g. egg-white, blood, etc.).

In the last 20 years, many product ideas (e.g. in cosmetics) were transferred to wet wipes. Impregnated wipes are applied widely as articles of daily use in a most diverse variety of areas. In addition to wet toilet paper, products such as wet baby wipes and—more recently—wet cleansing tissues were developed. In general, wet wipes allow efficient and gentle cleaning and care to be obtained. The actual article of use consists of two components:

a. a dry cloth built of materials such as paper and/or a wide variety of mixes of natural or synthetic fibres and

b. an impregnating solution which may incorporate substances having cleaning activity and other materials commonly used in the pertinent technology (such as water, conserving agents, perfume oils, etc.).

Equally known are cloths which are surface-structured or not, with their structures differing in accordance with the production method, which may be water-jet compaction or temperature embossing. In the area of textile care and cleaning, substrate or carrier materials comprise the so-called spunlace fabrics. This term defines the first kind of making the carrier material in which at least two different substances (cotton, synthetic fibres, viscose and others) are entangled by means of water jets, with the grammage varying between 30 and 200 g/m².

A wet cloth functioning as a detergent wipe has never been developed in the past as the use of a tenside in an impregnant solution did not produce the desired cleaning effect. Thus, a need continues to exist for a wet detergent wipe.

### SUMMARY OF THE INVENTION

It is one object of the present invention to provide a wet detergent wipe or sheet holding a material as soft and machine-durable as possible for the gentle care of textiles.

It is another object of the present invention to provide a wet wipe or sheet which is skin-friendly and long-lasting so that—in addition to textile cleaning—the sustainability aspect is intensified and expanded.

These objects are achieved by a method of making a wet detergent wipe which is characterized by the following steps: Adsorbing a tenside in the carrier material and impregnating with a detergent solution the carrier material so functionalized.

The wetted wipe so made follows from claim 2, which provides for a wet detergent wipe comprising a carrier material impregnated with a detergent solution and characterized in that a tenside has been adsorbed beforehand in the carrier material.

The dependent claims teach advantageous further embodiments of the wet detergent cloth.

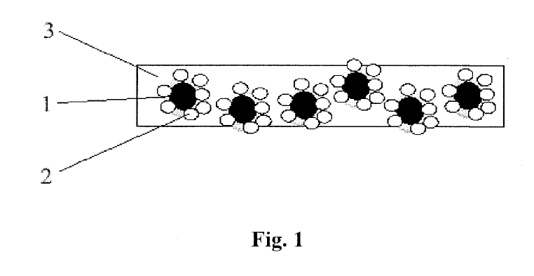

### DESCRIPTION OF FIG. 1

FIG. 1 schematically shows a cross-section through the carrier material.

### DESCRIPTION OF THE PREFERRED EMBODIMENTS

As in any wet wipe product, the detergent solution (described below in greater detail) and the carrier material must be combined with each other in the wet detergent wipe. In experiments the applicant has conducted to make wet detergent wipes, it has now been found that the additional phase the carrier material constitutes performs an important function, and this in addition to the lotion, which may comprise tensides, water, conserving agents, enzymes or other educts. In contradistinction to a single-phase product (powder or liquid), the two-phase nature of the wet wipe obviously results in a division of functions, and this regardless of whether the surface structure is embossed or smooth. A salient point is, however, the use of a machine-durable material as soft as possible for the gentle care of textiles.

As remarked above, wet detergent wipes have not been realized in the past as the use of a tenside via the impregnating solution did not produce a sufficient cleaning effect. Surprisingly, the inventive direct incorporation of a tenside in a carrier material has produced two effects: more intensive foaming, on the one hand, and a time effect caused by the tenside diffusing out into the cleaning environment, i.e. the washing fluid, on the other.

Another important effect relates to the fragrance imparted to the washed textiles, which creates an impression of freshness. Conventionally, 0.1 to 0.3% perfume oil are used in wet wipes. In a detergent, a markedly higher amount of a perfume oil is desirable so as to maximize the perception of freshness of the washed textile articles.

This problem was solved as well by the tenside, which determines part of the increase in viscosity, not being included in the detergent formula but being adsorbed directly beforehand in the sheet. This result in a more intensive bond of the perfume oil to the wipe surface so that it was possible to minimize the amount of tenside required in the detergent solution. In use, the wipe or sheet is introduced directly into the drum of the washing machine so as to enable a clean and direct dosing of the cleaning components to be obtained.

Thus, and for the first time, the inventive solution comprises the combination of a detergent solution with a functionalized carrier material, i.e. one into which a tenside was adsorbed beforehand. The result must be a homogenous impregnation of the carrier material. The carrier material so treated is illustrated in FIG. 1, i.e. a schematic cross-section showing fibres 1 with a tenside 2 adsorbed thereto, as well as the impregnating medium 3.

In accordance with the invention, the use in wet detergent wipes presupposes the adsorbing of appropriate amounts of the tenside phase in the carrier material phase and then impregnating the functionalized carrier material with a detergent lotion.

Advantageously, the impegnating medium contains enzymes. The following substances have shown to be particularly advantageous:
amylase
protease
sodium laureth sulphate
polyglyceryl-4 caprate
perfume

They were used together with a carrier material consisting of at least two components and treated with
sodium laureth sulphate
sodium lauryl sulphate
polyglyceryl-4 caprate

In addition to the aforesaid substances, the compositions may contain the additives conventionally used in detergents, such as perfume oil, conserving agents, plant extracts, actives, brighteners, enzymes or other conventional components of a detergent or washing formula.

| Raw Material | Lower Limit | Upper Limit |
|---|---|---|
| Water | ad 100 | ad 100 |
| Polyglyceryl-4 caprate | 8.455 | 8.645 |
| Dihydrogenated tallow ethyl | 4.45 | 4.55 |
| Hydroxyethylmonium methosulphate | | |
| Perfume | 4 | 4 |
| Disodium cocoamphodiacetate | 3.3 | 3.45 |
| Sodium laureth sulphate | 3 | 3 |
| Calcium chloride | 0.99 | 1 |
| Protease | 0.72 | 0.76 |
| Isopropanol | 0.45 | 0.55 |
| Propylene glycol | 0.475 | 0.495 |
| DMDM hydantoin | 0.1925 | 0.1925 |
| Triethanol amine | 0.099 | 0.1 |
| Subtilisin | 0.04 | 0.08 |
| α-amylase | 0.005 | 0.005 |

The exemplary formulation in the above table shows the possibilities of a cleaning or detergent formulation. Where a wet detergent wipe is used, the amount of detergent is a mere 7.5 g (corresponding to the impregnant used per wipe). Surprisingly, application tests of the wet detergent wipe have shown a higher efficiency (relative to the amount) than the conventional cleaning compositions.

1. A method of making a wet detergent wipe, characterized by the following steps:
Adsorbing a tenside in the carrier material and
impregnating with a detergent solution the carrier material so functionalized.

2. Wet detergent wipe, comprising a carrier material impregnated with a detergent solution, characterized in that a tenside has been adsorbed beforehand in the carrier material.

3. Wet detergent wipe as in claim 2, characterized in that the amount of impregnant is about 100 to 700 weight percent of lotion per wipe.

4. Wet detergent wipe as in claim 2 or 3, characterized in that the carrier material has a weight of 30 to 200 g/m².

5. The use of a wet detergent wipe as in any one of claims 2 to 4 for cleaning textile articles, involving the introduction of the wet detergent wipe into the drum of a washing machine.
